(19) United States
(12) Patent Application Publication
(10) Pub. No.: US 2013/0194144 A1
(43) Pub. Date: Aug. 1, 2013

(54) MULTI-RESONANCE TUNABLE ANTENNA

(71) Applicant: Sang Hak Lee, Seoul (KR)

(72) Inventor: Sang Hak Lee, Seoul (KR)

(73) Assignee: LG INNOTEK CO., LTD., Seoul (KR)

(21) Appl. No.: 13/877,299

(22) PCT Filed: Sep. 23, 2011
(86) PCT No.: PCT/KR2011/007029

§ 371 Date: Apr. 1, 2013

(30) Foreign Application Priority Data
Sep. 30, 2010 (KR) 10-2010-0095459

(51) Int. Cl. H01Q 9/14

(52) U.S. Cl. CPC H01Q 9/145
USPC 343/745

(57) ABSTRACT

Disclosed is a multi-resonance tunable antenna having a plurality of variable resonance points. The multi-resonance tunable antenna includes at least two branch lines and at least two capacitors. The at least two branch lines branch from a branch point of a basic line, which is connected to a filter used to receive wireless signals, in different directions. The at least two capacitors are connected between the at least two branch lines and a grounding terminal.

### TECHNICAL FIELD

The embodiment relates to an antenna. In particular, the present embodiment relates to a multi-resonance tunable antenna having a plurality of variable resonance points.

### BACKGROUND ART

The most basic principle of an antenna is resonance. The resonance is a phenomenon of mechanically and electrically selecting frequencies. The antenna has a structure in which signals are not propagated anymore like an open line. In this case, signals are resonant at a specific frequency thereof in the terminal of a line so that the signals are not subject to the total-reflection. In the resonance, signals having the corresponding frequency are not subject to the total-reflection, but energy generated in the form of an electromagnetic field is transmitted to the outside. Accordingly, as the reflection coefficient S11 for frequencies in the antenna is reduced, signal power for a corresponding frequency is not reflected but radiated to the outside as much as possible through the antenna.

FIG. 1 is a graph showing an electrical characteristic of an antenna having a wide frequency band.

Referring to FIG. 1, as the reflection coefficient S11 is reduced, the radiation efficiency of the antenna is increased, and superior matching is obtained. The width of a valley recessed downward in the graph serves as the frequency band of the antenna. In general, the size of the antenna is reduced as frequencies to be received are increased. In order to handle a wide frequency band through one antenna, a large antenna must be employed. Accordingly, an antenna for the wide frequency band is required without the increase in the size.

### DISCLOSURE OF INVENTION

### Technical Problem

The embodiment provides a multi-resonance tunable antenna having a plurality of variable resonance points.

### Solution to Problem

In order to accomplish the object, there is provided a multi-resonance tunable antenna including at least two branch lines and at least two capacitors. The at least two branch lines branch from a branch node of a basic line, which is connected to an impedance matching unit, in directions different from each other. The at least one capacitor is connected between the at least two branch lines and a grounding terminal.

### Advantageous Effects of Invention

As described above, according to the embodiment, a wide frequency band can be employed while reducing the size of the antenna.

### BRIEF DESCRIPTION OF DRAWINGS

FIG. 1 is a graph showing an electrical characteristic of an antenna having a wide frequency band;

FIG. 2 is a graph showing an example in which a tunable antenna having a single resonance point is used for a wide frequency band;

FIG. 3 is a view showing a multi-resonance tunable antenna according to a first embodiment;

FIG. 4 is a view showing a multi-resonance tunable antenna according to a second embodiment;

FIG. 5 is a view showing a multi-resonance tunable antenna according to a third embodiment;

FIG. 6 is a view showing the operating characteristic of a multi-resonance tunable antenna when two resonance points are used according to the embodiment; and

FIG. 7 is a view showing the operating characteristic of a multi-resonance tunable antenna when three resonance points are used according to the embodiment.

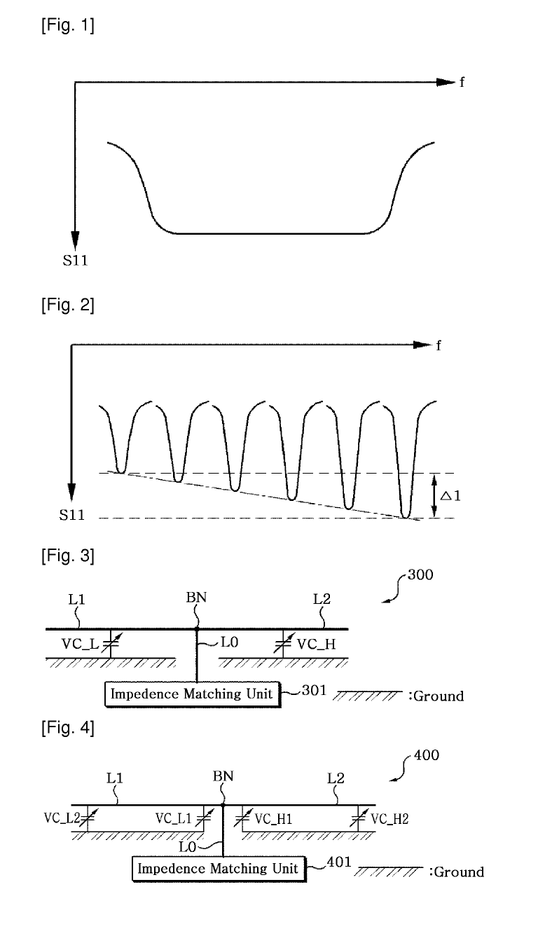

### MODE FOR THE INVENTION

Those skilled in the art should utilize accompanying drawings and concepts derived from the drawings for illustrating the embodiments by references in order to sufficiently comprehend the operating features of the embodiment and the object of the embodiment.

Hereinafter, the embodiments will be described in detail with reference to accompanying drawings, and the same reference numbers will be assigned to the same elements.

FIG. 2 is a graph showing an example in which a tunable antenna having a single resonance point is used for a wide frequency band.

Referring to FIG. 2, an antenna having a single resonance point has a narrow band characteristic. Accordingly, the antenna can be used for a wide frequency band by varying changing one resonance point. Since the antenna is used for the wide frequency band by changing only the value of one resonance point, there is the variation Δ1 between the reflection coefficient at the first resonance point and the reflection coefficient of the last resonance point. The chain line of FIG. 2 represents the gradient of the reflection coefficient for each resonant band.

The value of the reflection coefficient S11 shown in FIG. 2 is gradually reduced downward from a frequency axis f in FIG. 2. However, as described above, as the value of the reflection coefficient S11 is reduced, the antenna represents high radiation efficiency and superior matching. However, if the antenna is stable and represents superior performance, the variation Δ1 between reflection coefficients must represent a small value. Meanwhile, since the antenna has one resonance point, the resonance point must be changed six times in order to represent antenna characteristics in six frequency bands.

According to the embodiment, following effects can be obtained by using at least two resonance points.

First, even if the number of times to change the resonance point is more reduced, the antenna can be used for the wide frequency band.

Second, the difference between the reflection coefficient of the initial resonance point and the reflection coefficient of the last resonance point can be reduced.

FIG. 3 is a view showing a multi-resonance tunable antenna 300 according to the first embodiment.

Referring to FIG. 3, the multi-resonance tunable antenna 300 includes an impedance matching unit 301, a basic line L0, a first branch line L1, a second branch line L2, a first capacitor VC_L, and a second capacitor VC_H.

The impedance matching unit 301 is provided between an antenna and an antenna switch module (not shown) to perform impedance matching with respect to signals transmitted/received through the antenna. In this case, the impedance matching unit 301 can be realized by using devices such as an inductor and/or a capacitor.

The basic line L0 is connected to the impedance matching unit 301, and divided into the first branch line L1 and the second branch line L2 about a branch node BN. In this case, the number of lines branching from the branch node BN of the basic line L0 is used to determine the number of resonance points of the antenna. For example, as shown in FIG. 3, if two lines branch from the branch node BN, the antenna according to the embodiment has two resonance points.

The first branch line L1 and the second branch line L2 determine the values of resonance points together with a first capacitor VC_L and a second capacitor VC_H connected to the first branch line L1 and the second branch line L2, respectively. In general, it is well known to those skilled in the art that the resonance point is determined based on the lengths of the first and second branch lines L1 and L2 and values of capacitors realized between the first and second branch lines L1 and L2 and a grounding terminal. Accordingly, the detail thereof will be omitted in order to avoid redundancy.

One terminal of the first capacitor VC_L is connected to one point on the first branch line L1, and the other terminal of the first capacitor VC_L is connected to the grounding terminal. In addition, one terminal of the second capacitor VC_H is connected to one point on the second branch line L2, and the other terminal of the second capacitor VC_H is connected to the grounding terminal.

In order to change of the value of the resonance point, lengths of the first and second branch lines L1 and L2 may be changed. For example, the values of the resonance point are changed into the low frequency band by designing the first branch line L1 having a long length, and the value of the resonance point may be changed into the high frequency band by designing the second branch line L2 having a short length.

However, the embodiment suggests that the values of the resonance points are changed by changing the capacitance of the capacitors VC_L and VC_H. Therefore, preferably, the capacitors shown in FIG. 2 include variable capacitors having variable capacitances.

FIG. 4 is a view showing a multi-resonance tunable antenna 400 according to a second embodiment.

Referring to FIG. 4, the multi-resonance tunable antenna 400 has the same structure as that of the multi-resonance tunable antenna 300 shown in FIG. 3 except that two variable capacitors VC_L2 and VC_H2 are added to the multi-resonance tunable antenna 300. Accordingly, the details of a connection relation between capacitors will be omitted.

Two capacitors VC_L and VC_H shown in FIG. 3 correspond to two variable capacitors VC_L1 and VC_H1 of FIG. 4, respectively. Similarly to that of FIG. 3, capacitors shown in FIG. 4 may be realized as variable capacitors having variable capacitances.

The values of the resonance points vary according to points at which the two capacitors VC_L1 and VC_L2 are connected to the first branch line L1. One terminal of the variable capacitor VC_L1 is connected to the first branch line L1 close to the branch node BN, and one terminal of the other variable capacitor VC_L2 is connected to a terminal (end portion) of the first branch line L1.

Similarly, in two capacitors VC_H1 and VC_H2 connected to the second branch line

L2, one terminal of the capacitor VC H1 is connected to the second branch line L2 close to the branch node BN, and one terminal of the capacitor VC_H2 is connected to a terminal of the second branch line L2.

Differently from the antenna of FIG. 3, the variable capacitors VC_L2 and VC_H2 are additionally provided at the terminals of the first and second branch lines L1 and L2, respectively, so that a plurality of resonance points can be realized in the multi-resonance tunable antenna 400 according to the present embodiment to cover the wide frequency band. Further, in the antenna 400, the values of the resonance points can be finely adjusted.

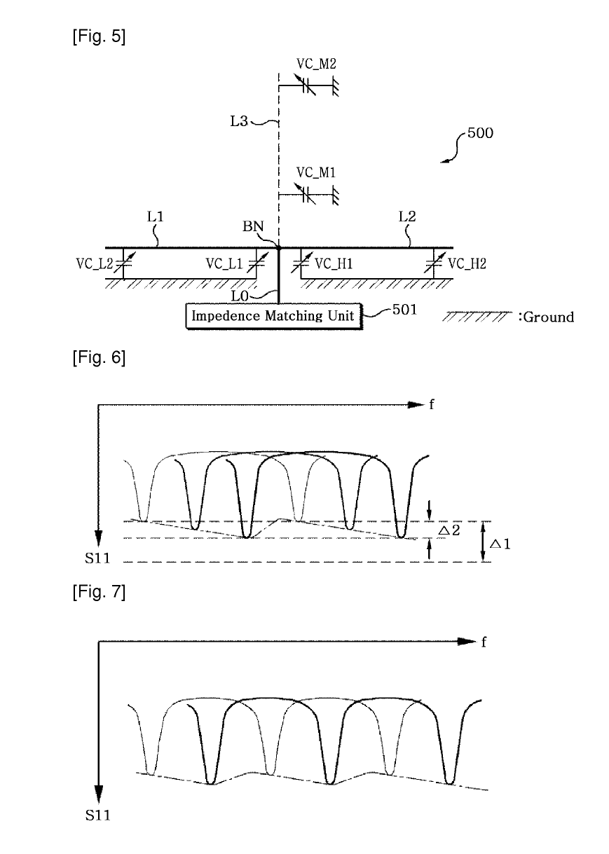

FIG. 5 is a view showing a multi-resonance tunable antenna 500 according to a third embodiment.

Referring to FIG. 5, the multi-resonance tunable antenna 500 has the same structure as that of the multi-resonance tunable antenna 400 shown in FIG. 4 except that a branch line L3 is added to the branch node BN of the multi-resonance tunable antenna 400. One terminal of two variable capacitors VC_M1 and VC_M2 is connected to the second branch line L3. The connection logic between the variable capacitors VC_M1 and VC_M2 is identical to the connection logic between the above variable capacitors according to the prior embodiments that has been already described.

Since the number of lines branching from the branch point BN of the basic line L0 is used to determine the number of resonance points, the multi-resonance tunable antenna 500 according to the present embodiment has three resonance points. For example, in the multi-resonance tunable antenna 500, a low-frequency band resonance point, a high-frequency band resonance point, and an intermediate-frequency band resonance point can be realized. Meanwhile, the present embodiment provides the antenna including three branch lines L1, L2, and L3 branching from the branch node BN, but is not limited thereto.

Although FIG. 5 shows that each of the branch lines L1 to L3 is connected to two variable capacitors, the technical spirit in which one capacitor is provided on each of the branch lines L1 to L3 is within the scope of the present disclosure.

In addition, the technical spirit in which at least one variable capacitor is additionally provided between two variable capacitors installed on each of the lines L1 to L3 is within the scope of the present disclosure.

In FIGS. 3, 4, and 5, the reference characters L, M, and H are assigned to capacitors. In this case, L, H, and M implicate that the capacitors exert influences on determining the positions of resonance points in a lower frequency band, a higher frequency band, and an intermediate frequency band.

Meanwhile, although the present embodiment has been described in that the value of a capacitor connected to each branch line varies in order to change the value of the resonance point, the embodiment is not limited thereto. In other words, the value of the resonance point can be changed while taking into both the length of each branch line and the value of the variable capacitor consideration.

FIG. 6 is a view showing the operating characteristic of a multi-resonance tunable antenna when two resonance points are used according to the embodiment.

Referring to FIG. 6, since two resonance points are used, two frequency bands are simultaneously available. Therefore, as shown in FIG. 2, when the two resonance points are used for six frequency bands, the values of the two resonance points may be changed only three times. In other words, an antenna having a desirable electrical characteristic can be realized even if the values of the resonance points are changed only in three steps.

Although the gradient of the reflection coefficient S11 at each resonance point is the same as that shown in FIG. 2, the desirable electrical characteristic can be realized only through three-step changes differently from that the desirable electrical characteristic is realized through six-step changes. Therefore, the deviation Δ2 between the reflection coefficients S11 is less than the deviation Δ1 between the reflection coefficients S11 shown in FIG. 2.

FIG. 7 is a view showing the operating characteristic of a multi-resonance tunable antenna when three resonance points are used according to the embodiment.

Since the operating characteristic of FIG. 7 can be comprehended by those skilled in the art based on the operating characteristic of FIG. 6, the detail thereof will be omitted. Since the object of the embodiment can be easily accomplished even if resonance points are changed only by two steps under the same conditions as those of FIGS. 2 and 6, the deviation between reflection coefficients is reduced as compared with the deviation between reflection coefficients of FIG. 6 as well as the deviation between reflection coefficients of FIG. 2.

As described above, in the multi-resonance tunable antenna according to the embodiment including at least two resonance points, the values of the resonance points are less changed in order to satisfy the characteristic of the wide frequency band. Accordingly, not only can the size of the multi-resonance tunable antenna be reduced, but also the deviation of the reflection coefficient can be reduced.

Any reference in this specification to one embodiment, an embodiment, example embodiment, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A multi-resonance tunable antenna comprising:
at least two branch lines branching from a branch node of a basic line, which is connected to an impedance matching unit, in directions different from each other; and
at least one capacitor connected respectively between the at least two branch lines and a grounding terminal.

2. The multi-resonance tunable antenna of claim 1, further comprising:
a first branch line branching from the branch node in a first direction;
a second branch line branching from the branch node in a second direction different the first direction;
a first capacitor between the first branch line and the grounding terminal; and
a second capacitor between the second branch line and the grounding terminal.

3. The multi-resonance tunable antenna of claim 1, wherein a value of a resonance point is changed by varying a value of the at least one capacitor.

4. The multi-resonance tunable antenna of claim 2, wherein the first and second capacitors include variable capacitors.

5. The multi-resonance tunable antenna of claim 2, further comprising:
a third capacitor between the first branch line and the grounding terminal; and
a fourth capacitor between the second branch line and the grounding terminal.

6. The multi-resonance tunable antenna of claim 5, wherein the first capacitor has one terminal connected to an end portion of the first branch line and another terminal that is grounded,
the third capacitor has one terminal connected to a point of the first branch line, which is close to the branch node, and another terminal that is grounded,
the second capacitor has one terminal connected to an end portion of the second branch line and another terminal that is grounded, and the fourth capacitor has one terminal connected to a point of the second branch line, which is close to the branch point, and another terminal that is grounded.

7. The multi-resonance tunable antenna of claim 5, further comprising:
at least one low-frequency band capacitor having one terminal connected between points of the first branch line connected to one terminal of the first and third capacitors, and another terminal that is grounded; and
at least one high-frequency band capacitor having one terminal connected between points of the second branch line connected to one terminal of the second and fourth capacitors, and another terminal that is grounded.

8. The multi-resonance tunable antenna of claim 7, wherein the first to fourth capacitors, the at least one low-frequency band capacitor, and the at least one high-frequency band capacitor include variable capacitors.

9. The multi-resonance tunable antenna of claim 2, further comprising:
a third branch line branching from the branch node in a third direction different the first and second directions; and
a fifth capacitor between the third branch line and the grounding terminal.

10. The multi-resonance tunable antenna of claim 9, wherein a frequency of a resonance point is changed by varying values of the first, second, and fifth capacitors.

11. The multi-resonance tunable antenna of claim 9, wherein the fifth capacitor is a variable capacitor.

12. The multi-resonance tunable antenna of claim 9, further comprising a sixth capacitor between the third branch line and the grounding terminal.

13. The multi-resonance tunable antenna of claim 12, wherein the fifth capacitor is provided between an end portion of the third branch line and the grounding terminal, and the sixth capacitor is provided between a point of the third branch line, which is close to the branch point, and the grounding terminal.

14. The multi-resonance tunable antenna of 12, wherein the fifth and sixth capacitors include variable capacitors.

15. The multi-resonance tunable antenna of claim 12, further comprising at least one intermediate-frequency band capacitor having one terminal connected to an intermediate point between points of the third branch line connected to one terminal of the fifth and sixth capacitors, and another terminal that is grounded.

16. The multi-resonance tunable antenna of claim 15, wherein the fifth capacitor, the sixth capacitor, and the at least one intermediate-frequency capacitor include variable capacitors.

17. The multi-resonance tunable antenna of claim 1, wherein a number of resonance points of the antenna corresponds to a number of lines branching from the branch node of the basic line.

18. The multi-resonance tunable antenna of claim 1, wherein a value of a resonance point is changed by varying a length of each branch line.

19. The multi-resonance tunable antenna of claim 18, wherein a frequency value of the resonance point is inverse-proportional to a length of each branch line.
